(19) United States
(12) Patent Application Publication
(10) Pub. No.: US 2011/0126957 A1
(43) Pub. Date: Jun. 2, 2011

(54) MULTI-LAYER FIRE PROTECTION MATERIAL

(76) Inventors: Michele WIERZBICKI, Salt Lake City, UT (US); Kenneth B. Miller, Lockport, NY (US); Joseph A. Fernando, Amherst, NY (US)

(21) Appl. No.: 12/945,012

(22) Filed: Nov. 12, 2010

Related U.S. Application Data
(60) Provisional application No. 61/261,082, filed on Nov. 13, 2009.

(51) Int. Cl. B32B 17/02; B32B 9/00; B32B 18/00; B32B 27/38; B32B 27/40; B32B 27/28; B32B 27/36; B32B 13/00; B31B 1/60

(52) U.S. Cl. 156/60; 162/123; 162/128

(57) ABSTRACT

A flexible or rigid multilayer material for fire protection applications. The multilayer fire protection material includes an inorganic fibrous layer and an endothermic layer. The layers of the fire protection material are bonded together to form a single sheet material without the use of auxiliary bonding means.

### CROSS REFERENCE TO RELATED APPLICATIONS

This application claims the benefit of the filing date, under 35 U.S.C. §119(e), of United States Provisional Application for Patent Ser. No. 61/261,082, filed on Nov. 13, 2009.

### TECHNICAL FIELD

A multilayer fire protection material is provided comprising a fibrous layer and endothermic layer bonded together to form a unitary sheet without the use of auxiliary bonding means. The fire protection material may be in the form of flexible, semi-rigid or rigid sheets or boards or may be molded into a wide variety of shapes.

### BACKGROUND

There is a continuing need for fire protective materials that maintain the integrity of pipes and prevent ignition of hydrocarbon products within pipes in the event of a fire. Current commercially available insulation systems for fire protection of conduits and process pipe work for both offshore and onshore oil production and processing facilities typically involve a two-layer system consisting of a first layer of foamed fiberglass material, and a second layer of high temperature fiber blanket constructed from alumino-silicate fibers, silicate fibers, mineral fibers, or a combination of such fibers. The system is fabricated on-site by first applying the foamed fiberglass layer around the article to be protected, then wrapping the high temperature blanket over the fiberglass material. The system is protected from weather/erosion by a stainless steel jacket. The fiberglass material is typically about 38 mm thick and the blanket is typically about 25 mm thick. The system is thick and bulky, the installation of separate layers that must be individually mounted in situ is time-consuming, and the fabricators do not necessarily like working with the foamed fiberglass product.

Known bonded multilayer mats are typically made by first separately forming the layers and then bonding the layers together using an adhesive, a film or other means, such as, for example, stitches or staples. The adhesive or film bonding layer affects the thermal properties of the mat, and increases the manufacturing cost. Mechanically bonded or attached multilayered mats are disadvantageous due to the expense of added steps and materials and the weakness of the mat at the point of mechanical attachment such as where stitches or staples perforate the mat.

It is known to provide materials designed to retard the spread of fire and heat by an endothermic reaction. For example, a known fire protection material comprises an endothermic-reactive insulating fibrous material comprising (a) an inorganic endothermic filler which undergoes multiple endothermic reactions, (b) inorganic fiber material; and (c) an organic polymer binder. Another known endothermic fire-protective sheet comprises (a) refractory inorganic fiber; (b) an organic polymer binder, and (c) an inorganic, endothermic filler that undergoes an endothermic reaction. Furthermore, vacuum formed, fire protective shaped fibrous products are disclosed in various forms.

However, the combination of an inorganic fibrous layer and an endothermic layer bonded together to form a compact, unitary, multilayer fire-protection material without the use of auxiliary bonding means has not previously been utilized or disclosed in the fire protection industry. While the known fire protection materials have their own utilities, performance attributes and advantages, there remains an ongoing need for unitary, fire protection materials having multiple layers bonded together to form a single sheet without the use of auxiliary bonding means, that possess a reduced thickness as compared to commercially available insulation systems, are easier to handle and require less space, labor and time to install than two separate layers, and are suitable for protecting pipe work in oil production and processing facilities.

### BRIEF DESCRIPTION OF THE DRAWING

FIG. 1 is a graph depicting the effect of endothermic material and position on flame test results for the inventive multilayer fire protection material as well as prior art fire protection material.

### DETAILED DESCRIPTION

Provided is a multilayer fire protection material comprising (a) a fibrous layer comprising inorganic fibers and optionally a binder; and (b) an endothermic layer comprising inorganic fibers, a binder, and an inorganic, endothermic filler, the layers bonded together to form a unitary sheet without the use of auxiliary bonding means.

Also provided is a method of forming a multilayer fire protection material comprising the steps of (a) providing at least a first liquid slurry containing materials suitable for making a fibrous layer and at least a second aqueous slurry containing materials suitable for making an endothermic layer; (b) depositing the first slurry onto a substrate; (c) removing at least a portion of the liquid from the first slurry on the substrate to form a first fibrous layer; (d) depositing the second slurry so as to form a second endothermic layer on the first fibrous layer; (e) removing at least a portion of the liquid from the second layer; and (f) drying the layers to form a multilayer material.

According to certain illustrative embodiments, the multilayer fire protection material comprises (a) a fibrous layer comprising heat resistant inorganic fibers and a binder; and (b) an endothermic layer comprising heat resistant inorganic fibers, a binder, and an inorganic, endothermic filler. The layers of the multilayer fire protection material are bonded together to form a single sheet without the use of an auxiliary or independent bonding means.

According to illustrative embodiments, the multilayer fire protection material comprises (a) a fibrous layer comprising from about 0 weight percent to about 20 weight percent binder, and from about 80 to about 100 weight percent inorganic fiber; and (b) an endothermic layer comprising from about 1 to about 20 weight percent binder; from about 20 to less than 100 weight percent inorganic fiber; and from greater than 0 to about 80 weight percent endothermic filler.

According to additional illustrative embodiments, the multilayer fire protection material comprises (a) a fibrous layer comprising from about 3 weight percent to about 12 weight percent binder and from about 88 to about 97 weight percent inorganic fiber; and (b) an endothermic layer comprising from about 3 to about 12 weight percent binder; from about 70 to about 90 weight percent inorganic fiber; and from about 3 to about 12 weight percent endothermic filler.

The multilayer fire protection material may also comprise (a) a fibrous layer comprising about 95.5 weight percent inorganic fibers and about 4.5 weight percent binder; and (b) an endothermic layer comprising from about 89.5 weight percent inorganic fibers; from about 4.5 weight percent binder; and from about 6.0 weight percent inorganic, endothermic filler.

It should be noted that according to alternative embodiments, the fibrous layer of the multilayer fire protection material may be devoid of binder, while the endothermic layer includes a binder.

According to certain embodiments, the high temperature resistant inorganic fibers that may be used to prepare the fire protection material include, without limitation, high alumina polycrystalline fibers, refractory ceramic fibers such as alumino-silicate fibers, alumina-magnesia-silica fibers, alumina-zirconia-silica fibers, zirconia-silica fibers, zirconia fibers, kaolin fibers, mineral wool fibers, alkaline earth silicate fibers such as calcia-magnesia-silica fibers and magnesia-silica fibers, S-glass fibers, S2-glass fibers, E-glass fibers, quartz fibers, silica fibers and combinations thereof.

According to certain embodiments, the mineral wool fibers that may be used to prepare the endothermic fire protection material include, without limitation, at least one of rock wool fibers, slag wool fibers, basalt fibers, and glass fibers.

Without limitation, suitable refractory ceramic fibers (RCF) typically comprises alumina and silica, and typically contain from about 45 to about 60 percent by weight alumina and from about 40 to about 55 percent by weight silica. The RCF fibers are a fiberization product that may be blown or spun from a melt of the component materials. RCF may additionally comprise the fiberization product of alumina, silica and zirconia, in certain embodiments in the amounts of from about 29 to about 31 percent by weight alumina, from about 53 to about 55 percent by weight silica, and about 15 to about 17 weight percent zirconia. RCF fiber length is typically less than about 5 mm, and the average fiber diameter range is from about 0.5 μm to about 12 μm.

A useful refractory alumina-silica ceramic fiber is commercially available from Unifrax I LLC (Niagara Falls, N.Y.) under the registered trademark FIBERFRAX. The FIBERFRAX ceramic fibers comprise the fiberization product of about 45 to about 75 weight percent alumina and about 25 to about 55 weight percent silica. The FIBERFRAX fibers exhibit operating temperatures of up to about 1540° C. and a melting point up to about 1870° C.

According to certain embodiments, the refractory ceramic fibers useful in this embodiment are melt-formed ceramic fibers containing alumina and silica, including but not limited to melt spun refractory ceramic fibers. These include aluminosilicates, such as those aluminosilicate fibers having from about 40 to about 60 percent alumina and from about 60 to about 40 percent silica, and some embodiments, from about 47 to about 53 percent alumina and from about 47 to about 53 percent silica.

The FIBERFRAX fibers are easily formed into high temperature resistant sheets and papers. The FIBERFRAX fibers are made from bulk alumino-silicate glassy fiber having approximately 50/50 alumina/silica and a 70/30 fiber/shot ratio. About 93 weight percent of this paper product is ceramic fiber/shot, the remaining 7 percent being in the form of an organic latex binder.

The high temperature resistant inorganic fibers may include polycrystalline oxide ceramic fibers such as mullite, alumina, high alumina aluminosilicates, aluminosilicates, titania, chromium oxide and the like. Suitable polycrystalline oxide refractory ceramic fibers and methods for producing the same are contained in U.S. Pat. Nos. 4,159,205 and 4,277,269, which are incorporated herein by reference. FIBERMAX® polycrystalline mullite ceramic fibers are available from Unifrax I LLC (Niagara Falls, N.Y.) in blanket, mat or paper form.

The alumina/silica FIBERMAX® fibers comprise from about 40 weight percent to about 60 weight percent Al₂O₃ and about 60 weight percent to about 40 weight percent SiO₂. The fiber may comprise about 50 weight percent Al₂O₃ and about 50 weight percent SiO₂. The alumina/silica/magnesia glass fiber typically comprises from about 64 weight percent to about 66 weight percent SiO₂, from about 24 weight percent to about 25 weight percent Al₂O₃, and from about 9 weight percent to about 10 weight percent MgO. The E-glass fiber typically comprises from about 52 weight percent to about 56 weight percent SiO₂, from about 16 weight percent to about 25 weight percent CaO, from about 12 weight percent to about 16 weight percent Al₂O₃, from about 5 weight percent to about 10 weight percent B₂O₃, up to about 5 weight percent MgO, up to about 2 weight percent of sodium oxide and potassium oxide and trace amounts of iron oxide and fluorides, with a typical composition of 55 weight percent SiO₂, 15 weight percent Al₂O₃, 7 weight percent B₂O₃, 3 weight percent MgO, 19 weight percent CaO and traces of the above mentioned materials.

The fibers may comprise at least one of an amorphous alumina/silica fiber, an alumina/silica/magnesia fiber (such as S-2 Glass from Owens Corning, Toledo, Ohio), mineral wool, E-glass fiber, magnesia-silica fibers, such as ISOFRAX® fibers from Unifrax I LLC, Niagara Falls, N.Y., or calcia-magnesia-silica fibers, such as INSULFRAX® fibers from Unifrax I LLC, Niagara Falls, N.Y. or SUPERWOOL™ fibers from Thermal Ceramics Company.

According to other embodiments, biosoluble alkaline earth silicate fibers can be used to prepare the intumescent fire protection materials. Suitable alkaline earth silicate fibers include those biosoluble alkaline earth silicate fibers disclosed in U.S. Pat. Nos. 6,953,757, 6,030,910, 6,025,288, 5,874,375, 5,585,312, 5,332,699, 5,714,421, 7,259,118, 25 7,153,796, 6,861,381, 5,955,389, 5,928,075, 5,821,183, and 5,811,360, each of which are hereby incorporated by reference.

The biosoluble alkaline earth silicate fibers may comprise the fiberization product of a mixture of oxides of magnesium and silica. These fibers are commonly referred to as magnesium-silicate fibers. The magnesium-silicate fibers generally comprise the fiberization product of about 60 to about 90 weight percent silica, from greater than 0 to about 35 weight percent magnesia and 5 weight percent or less impurities. According to certain embodiments, the alkaline earth silicate fibers comprise the fiberization product of about 65 to about 86 weight percent silica, about 14 to about 35 weight percent magnesia and 10 weight percent or less impurities. According to other embodiments, the alkaline earth silicate fibers comprise the fiberization product of about 70 to about 86 weight percent silica, about 14 to about 30 weight percent magnesia, and 10 weight percent or less impurities. A suitable magnesium silicate fiber is commercially available from Unifrax I LLC (Niagara Falls, N.Y.) under the registered trademark ISOFRAX. Commercially available ISOFRAX fibers generally comprise the fiberization product of about 70 to about 80 weight percent silica, about 18 to about 27 weight percent magnesia and 4 weight percent or less impurities. ISOFRAX alkaline earth silicate fibers may have an average diameter of about 1 micron to about 3.5 microns; in some embodiments, about 2 to about 2.5 microns.

The biosoluble alkaline earth silicate fibers may alternatively comprise the fiberization product of a mixture of oxides of calcium, magnesium and silica. These fibers are commonly referred to as calcia-magnesia-silica fibers. According to certain embodiments, the calcia-magnesia-silicate fibers comprise the fiberization product of about 45 to about 90 weight percent silica, from greater than 0 to about 45 weight percent calcia, from greater than 0 to about 35 weight percent magnesia, and 10 weight percent or less impurities. Useful calcia-magnesia-silicate fibers are commercially available from Unifrax I LLC (Niagara Falls, N.Y.) under the registered trademark INSULFRAX. INSULFRAX fibers generally comprise the fiberization product of about 61 to about 67 weight percent silica, from about 27 to about 33 weight percent calcia, and from about 2 to about 7 weight percent magnesia. Other suitable calcia-magnesia-silicate fibers are commercially available from Thermal Ceramics (Augusta, Ga.) under the trade designations SUPERWOOL 607 and SUPERWOOL 607 MAX and SUPERWOOL HT. SUPERWOOL 607 fibers comprise about 60 to about 70 weight percent silica, from about 25 to about 35 weight percent calcia, and from about 4 to about 7 weight percent magnesia, and trace amounts of alumina. SUPERWOOL 607 MAX fibers comprise about 60 to about 70 weight percent silica, from about 16 to about 22 weight percent calcia, and from about 12 to about 19 weight percent magnesia, and trace amounts of alumina. SUPERWOOL HT fibers comprise about 74 weight percent silica, about 24 weight percent calcia and trace amounts of magnesia, alumina and iron oxide.

According to certain embodiments, the intumescent fire protection materials may optionally comprise other known non-respirable inorganic fibers (secondary inorganic fibers) such as silica fibers, leached silica fibers (bulk or chopped continuous), S-glass fibers, S2 glass fibers, E-glass fibers, fiberglass fibers, chopped continuous mineral fibers (including but not limited to basalt or diabasic fibers) and combinations thereof and the like, suitable for the particular temperature applications desired. Such inorganic fibers may be added to the panel in quantities of from greater than 0 to about 40 percent by weight, based upon 100 percent by weight of the total panel.

The secondary inorganic fibers are commercially available. For example, leached silica fibers may be leached using any techniques known in the art, such as by subjecting glass fibers to an acid solution or other solution suitable for extracting the non-siliceous oxides and other components from the fibers. A process for making leached glass fibers is contained in U.S. Pat. No. 2,624,658 and in European Patent Application Publication No. 0973697.

Examples of suitable leached glass fibers include those leached glass fibers available from BelChem Fiber Materials GmbH, Germany, under the trademark BELCOTEX and from Hitco Carbon Composites, Inc. of Gardena, Calif., under the registered trademark REFRASIL, and from Polotsk-Steklovolokno, Republic of Belarus, under the designation PS-23(R).

Generally, the leached glass fibers will have a silica content of at least 67 percent by weight. In certain embodiments, the leached glass fibers contains at least 90 percent by weight, and in certain of these, from about 90 percent by weight to less than 99 percent by weight silica. The fibers are also substantially shot free.

The average fiber diameter of these leached glass fibers may be greater than at least about 3.5 microns, and often greater than at least about 5 microns. On average, the glass fibers typically have a diameter of about 9 microns, up to about 14 microns. Thus, these leached glass fibers are non-respirable.

The BELCOTEX fibers are standard type, staple fiber pre-yarns. These fibers have an average fineness of about 550 tex and are generally made from silicic acid modified by alumina. The BELCOTEX fibers are amorphous and generally contain about 94.5 silica, about 4.5 percent alumina, less than 0.5 percent sodium oxide, and less than 0.5 percent of other components. These fibers have an average fiber diameter of about 9 microns and a melting point in the range of 1500° to 1550° C. These fibers are heat resistant to temperatures of up to 1100° C., and are typically shot free and binder free.

The REFRASIL fibers, like the BELCOTEX fibers, are amorphous leached glass fibers high in silica content for providing thermal insulation for applications in the 1000° to 1100° C. temperature range. These fibers are between about 6 and about 13 microns in diameter, and have a melting point of about 1700° C. The fibers, after leaching, typically have a silica content of about 95 percent by weight. Alumina may be present in an amount of about 4 percent by weight with other components being present in an amount of 1 percent or less.

The PS-23 (R) fibers from Polotsk-Steklovolokno are amorphous glass fibers high in silica content and are suitable for thermal insulation for applications requiring resistance to at least about 1000° C. These fibers have a fiber length in the range of about 5 to about 20 mm and a fiber diameter of about 9 microns. These fibers, like the REFRASIL fibers, have a melting point of about 1700° C.

In certain alternative embodiments, fibers such as S2-glass and the like may be added to the intumescent fire protection materials in quantities of from greater than 0 to about 50 percent by weight, based upon 100 percent by weight of the material. S2-GLASS fibers typically contain from about 64 to about 66 percent silica, from about 24 to about 25 percent alumina, and from about 9 to about 10 percent magnesia. S2-GLASS fibers are commercially available from Owens Corning, Toledo, Ohio.

In other alternative embodiments, the panel may include refractory ceramic fibers in addition to the leached glass fibers. When refractory ceramic fibers, that is, alumina/silica fibers or the like are utilized, they may be present in an amount ranging from greater than 0 to less than about 50 percent by weight, based upon 100 percent by weight of the total panel.

The FIBERFRAX refractory ceramic fibers may have an average diameter of about 1 micron to about 12 microns. The other inorganic fibers, such as S2 glass fibers may have an average diameter of about 5 microns to about 15 microns; in some embodiments, about 9 microns.

The multilayer fire protection material includes a binder or mixture of more than one type of binder. Suitable binders include organic binders, inorganic binders and mixtures of these two types of binders. According to certain embodiments, the multilayer fire protection material includes one or more organic binders. The organic binders may be provided as a solid, a liquid, a solution, a dispersion, a latex, or similar form. The organic binder may comprise a thermoplastic or thermoset binder, which after cure is a flexible material. Examples of suitable organic binders include, but are not limited to, acrylic latex, (meth)acrylic latex, copolymers of styrene and butadiene, vinylpyridine, acrylonitrile, copolymers of acrylonitrile and styrene, vinyl chloride, polyurethane, copolymers of vinyl acetate and ethylene, polyamides, silicones, and the like. Other resins include low temperature, flexible thermosetting resins such as unsaturated polyesters, epoxy resins and polyvinyl esters. According to certain embodiments, the multilayer fire protection material utilizes an acrylic resin binder.

Alternatively, organic binders based on natural polymers may be used as the binder component of the fire protection material. Without limitation, and only by way of illustration, a suitable organic binder that may be used in the fire material may comprise a starch polymer, such as a starch polymer that is derived from corn or potato starch.

The multilayer fire protection material may also include an inorganic binder in addition to or in place of the organic binder. In the event that an inorganic binder is included in the fire protection material, the inorganic binder may selected from colloidal silica, colloidal alumina, colloidal zirconia, mixtures thereof and the like. For certain embodiments directed to a rigid multilayer board, an inorganic binder system such as colloidal silica is used in conjunction with an organic additive such as starch to retain the binder. For a semi-rigid or flexible multilayer board, an organic latex type binder system, such as an acrylic resin, is used in conjunction with an additive/catalyzer such as alum to retain the binder.

The binder may be included in the fibrous layer in an amount from about 1 to about 20 weight percent, and preferably about 4.5 weight percent, based on the total weight of the fibrous layer, with the remainder comprising inorganic fiber.

The binder may be included in the endothermic layer in an amount from about 1 to about 20 weight percent binder; and preferably about 4.5 weight percent, based on the total weight of the endothermic layer, with the remainder comprising from about 20 to about 100 weight percent inorganic fiber and greater than 0 to about 20 weight percent endothermic filler.

The endothermic filler may be selected from alumina trihydrate, magnesium carbonate, and other hydrated inorganic materials including cements, hydrated zinc borate, calcium sulfate (also known as gypsum), magnesium ammonium phosphate, magnesium hydroxide and combinations thereof.

According to certain embodiments, the weight ratio of the endothermic filler to the inorganic fiber may be in the range of about 0.25:1 to about 30:1.

According to further embodiments, the fire protection material may include a water repellant additive. Without limitation, the water repellant material may comprise a water repellant silicone additive in an amount of about 5 weight percent or less based on the total weight of the fire protection material, or in amount of about 1 weight percent or less based on the total weight of the fire protection material.

The process for preparing the fire protection sheet material generally includes preparing a high temperature resistant fiber layer and an endothermic layer. The process for preparing the multilayer fire protection material includes preparing a sheet material comprising (a) a fibrous layer comprising inorganic fibers and a binder; and (b) an endothermic layer comprising inorganic fibers, a binder, and an inorganic, endothermic filler, the layers bonded together to form a single sheet without the use of auxiliary bonding means.

The method of forming a multilayer fire protection material comprises (a) providing at least a first liquid slurry containing materials for making a fibrous layer and at least a second liquid slurry containing materials for making an endothermic layer; (b) depositing the first slurry onto a substrate; (c) removing at least a portion of the liquid from the first slurry on the substrate to form a first fibrous layer; (d) depositing the second slurry so as to form a second endothermic layer on the first fibrous layer; (e) removing at least a portion of the second layer; and (f) drying the layers to form a multilayer material.

According to certain embodiments, the method may include (a) providing a first aqueous slurry containing materials suitable for making a fibrous layer and a second aqueous slurry containing materials suitable for making an endothermic layer; (b) depositing the first slurry onto a substrate; (c) partially dewatering the first slurry on the substrate to form a fibrous layer; (d) depositing the second slurry so as to form an endothermic layer on the fibrous layer; (e) partially dewatering the second layer; and (f) drying the layers to form a multilayer material.

The material may be formed by a double-dipping vacuum forming technique. The fibrous layer is formed first onto a wire mesh and then the endothermic layer is formed on top of the fibrous layer. The fibrous layer solution is mixed and pumped into a first vacuum chamber where a fibrous sheet is formed. While still wet, the formed fibrous sheet is then immersed into a second dip tank containing the endothermic layer solution and the second layer is formed on top of the fibrous layer. The wet sheets are then dried, typically in an oven. The sheet may be passed through a set of rollers to compress the sheet prior to drying.

The multilayer fire protection material may also be produced in any other suitable way known in the art for forming sheet-like materials. For example, conventional papermaking processes, either hand laid or machine laid, may be used to prepare the multilayer sheet material. A handsheet mold, a Fourdrinier paper machine, or a rotoformer paper machine can be employed to make the multilayer sheet material. For a more detailed description of standard papermaking techniques employed, see U.S. Pat. No. 3,458,329, the disclosure of which is incorporated herein by reference.

Regardless of which of the above-described techniques are employed, the multilayer material may be cut, such as by die stamping, to form boards of exact shapes and sizes with reproducible tolerances. The material may also be molded into conduit sections or sections specially shaped to encapsulate particular components, such as half pipe shapes. The product is then attached to the article to be protected by means such as banding or impaling over pins. The material is preferably oriented so that the endothermic layer of the material faces the non-fire side of the article. The endothermic layer of the material absorbs heat that would otherwise build up, for instance, on the pipe interior, causing the system to fail a jet fire test. A stainless steel jacket is typically placed over the material for additional protection.

Flexible, semi-rigid, or rigid multilayer fire protective boards or formed shapes in a range of thicknesses can be produced. Boards or formed shapes that are about 30 to about 50 mm thick are especially useful in firestop applications. Multilayer sheets of lesser thickness may be stacked to produce thicker material as a given application requires. The thickness of the material is determined by the fire protection required. Variations in the composition of the boards lead to changes in its density in the range of about 0.04 to about 0.5 grams/cm³.

### EXAMPLES

The following examples are intended to merely further exemplify illustrative embodiments of the multilayer fire protection material and the process for preparing the material. It should be understood that these examples are for illustration only and should not be considered as limiting the claimed multilayer fire protection material, the process for preparing the multilayer fire protection materials, products incorporating the multilayer fire protection material and processes for using the multilayer fire protection material in any manner.

Samples of the multilayer fire protection material were prepared for testing using sheet materials comprising the formulations as set forth in Table 1, and produced as described below.

TABLE 1
Multilayer Fire Protection Material Composition (weight percent)

| | | Inventive | |
|---|---|---|---|
| | Comparative Ex. 1 | Ex. 1 | Inventive Ex. 2 |
| Fibrous Layer | | | |
| Fiber¹ | 95 | 95.5 | 95.5 |
| Binder² | 5 | 4.5 | 4.5 |
| Endothermic Layer | | | |
| Fiber³ | | 89.5 | 89.5 |
| Binder⁴ | | 4.5 | 4.5 |
| Endothermic Filler⁵ | | 6.0 | 6.0 |

Fiber^{1,3} = Isofrax magnesia-silica fibers (Unifrax)
Binder² = HyCar Latex 26083 (Noveon); Nalco 1141 Colloidal Silica (Nalco)
Binder⁴ = HyCar Latex (Noveon)
Endothermic Filler⁵ = Aluminum Trihydrate (Alfa Aesa)

The formulation ingredients for the multilayer fire protection material were combined, mixed, and formed into sheets in accordance with the method described above. Briefly, a first liquid slurry containing the ISOFRAX fiber and binder for making a fibrous layer was prepared and a second liquid slurry containing the ISOFRAX fiber, binder and endothermic materials for making an endothermic layer was prepared. The first liquid slurry was deposited onto a substrate and a portion of the liquid was removed from the first slurry on the substrate to form a first fibrous layer. The second liquid slurry was deposited onto the first fibrous layer so as to form an endothermic layer on the first fibrous layer. A portion of the liquid was removed from the second layer, and the layers were dried to form a multilayer fire protection material.

The multilayer fire protection sheet material may have a basis weight in the range from about 100 to about 6,000 g/m². According to other embodiments, the sheet material may have a basis weight in the range of about 500 to about 3000 g/m².

The layers of the multiple layer fire protection material are bonded together without the use of an auxiliary or separately applied bonding means, and may be handled without breaking or cracking. The material of Example 1 was flexible and the material of Example 2 was rigid. These extremes were used to demonstrate that the material could be manufactured as a flexible material, as a rigid material or as a semi-rigid material depending upon the desired application of the material.

### Flame Test

The flame resistance of the multilayer fire protection material was evaluated using a flame test. The test specimens of the multiple layer fire protection material were cut or formed to measure approximately 18″×22″ for sidewall tests and 24″×24″ for ceiling tests. The specimens were tested in a 24″×24″ gas fuelled test furnace using a hydrocarbon test curve.

Comparative Example 1 was prepared for purposes of testing as a control against Examples 2 and 3. Comparative Example 1 was assembled without an endothermic layer. Examples 2 and 3 have the same composition but differ in orientation of the multilayer fire protection material. Example 2 was oriented so that the endothermic layer of the material faces the coldside (non-fire side) of an article to be protected. In Example 3, the material was oriented so that the endothermic layer faces the hotside (fire side) of an article to be protected.

The results of the Flame Testing of the multiple layer fire protection material are set forth below:

### Comparative Example 1: 0.7/50 mm Flex/10 mm air

Inventive Example 2: 0.7/8 mm endo/40 mm Flex/10 mm air
Inventive Example 3: 0.7/40 mm Flex/8 mm endo/10 mm air

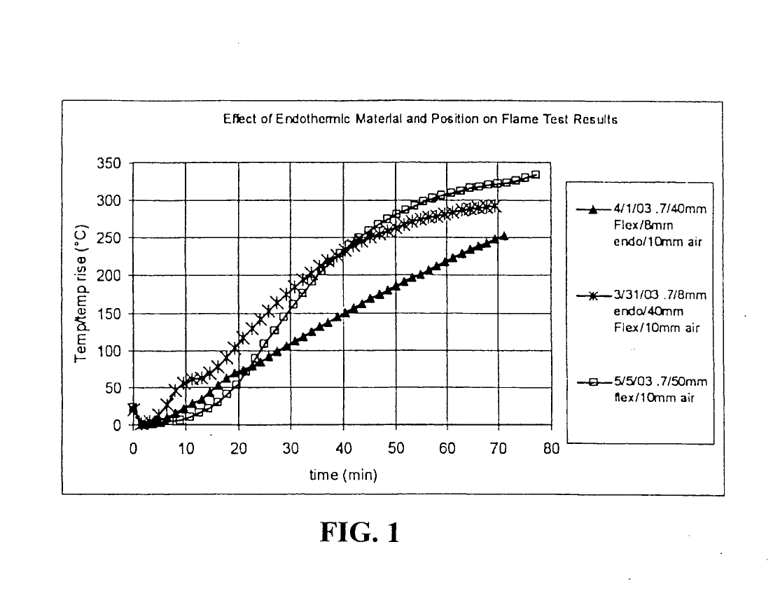

FIG. 1 demonstrates the effect on flame test results of a fire protection material including an endothermic layer and the effect on flame test results of positioning the endothermic layer on the fire or non-fire side of an article to be protected. A 50 mm board having a fibrous layer but no endothermic layer is compared to equivalent 40 mm multilayer fire protection boards comprising a fibrous layer and an 8 mm endothermic layer. The multilayer boards were placed both on the fire side and on the non-fire side of articles to be protected. The results show that multilayer boards having fibrous and endothermic layers performed better on flame tests as compared to a fire protection board having just a fibrous layer. Best results, i.e., the lowest cold face temperature rise, were observed when the endothermic layer was placed on the non-fire side of the article to be protected. The flame tests were conducted on a flat wall. In a closed pipe system, the advantage of an endothermic layer is expected to be more dramatic.

The fire protection material is particularly useful as a compact wrap to protect cables and conduits, of particular importance in areas of limited space such as airframe structures.

While the multilayer fire protection material and process for preparing the same have been described in connection with various illustrative embodiments, it is to be understood that other similar embodiments may be used or modifications and additions may be made to the described embodiments for performing the same function disclosed herein without deviating therefrom. The embodiments described above are not necessarily in the alternative, as various embodiments may be combined to provide the desired characteristics. Therefore, the multiplayer fire protection material and process should not be limited to any single embodiment, but rather construed in breadth and scope in accordance with the recitation of the appended claims.

1. A multilayer fire protection material comprising:
(a) a fibrous layer comprising inorganic fibers and a optionally binder; and
(b) an endothermic layer comprising inorganic fibers, a binder, and an inorganic, endothermic filler,
said layers bonded together to form a unitary sheet without the use of auxiliary bonding means.

2. The material of claim 1, wherein said inorganic fibers are selected from the group consisting of high alumina polycrystalline fibers, ceramic fibers, kaolin fibers, mineral wool fibers, alkaline earth silicate fibers, S-glass fibers, S2-glass fibers, E-glass fibers, quartz fibers, silica fibers and combinations thereof.

3. The material of claim 2, wherein said inorganic fibers comprise ceramic fibers.

4. The material of claim 3, wherein said ceramic fibers comprise aluminosilicate fibers.

5. The material of claim 4, wherein said aluminosilicate fibers comprise the fiberization product of about 45 to about 75 weight percent alumina and about 25 to about 55 weight percent silica.

6. The material of claim 2, wherein said inorganic fibers comprise alkaline earth silicate fibers.

7. The material of claim 6, wherein said alkaline earth silicate fibers comprise at least one of calcia-magnesia-silica fibers and magnesia-silica fibers.

8. The material of claim 7, wherein said magnesia-silica fibers comprise the fiberization product of about 65 to about 86 weight percent silica, about 14 to about 35 weight percent magnesia and about 5 weight percent or less impurities.

9. The material of claim 7, wherein said calcia-magnesia-silica fibers comprise the fiberization product of about 45 to about 90 weight percent silica, greater than about 0 to about 45 weight percent calcia, and greater than 0 to about 35 weight percent magnesia.

10. The material of claim 1, wherein said binder comprises an organic binder.

11. The material of claim 10, wherein said organic binder comprises a thermosetting binder, wherein said organic binder is selected from the group consisting of acrylic latex, (meth)acrylic latex, copolymers of styrene and butadiene, vinylpyridine, acrylonitrile, copolymers of acrylonitrile and styrene, vinyl chloride, polyurethane, copolymers of vinyl acetate and ethylene, polyamides, silicones, polyesters, epoxy resins, polyvinyl esters and mixtures thereof.

12. The material of claim 10, wherein said organic binder comprises a thermoplastic binder.

13. The material of claim 11, wherein said acrylic latex binder comprises an acrylic resin and further comprises alum as an additional binder.

14. The material of claim 1, wherein said binder comprises an inorganic binder, wherein said inorganic binder is selected from the group consisting of colloidal silica, colloidal alumina, colloidal zirconia and combinations thereof.

15. The material of claim 14, wherein said inorganic binder is colloidal silica and further comprises starch as an additional binder.

16. The material of claim 1, wherein said endothermic filler is selected from the group consisting of alumina trihydrate, magnesium carbonate, and other hydrated inorganic materials including cements, hydrated zinc borate, calcium sulfate (also known as gypsum), magnesium ammonium phosphate, magnesium hydroxide and combinations thereof.

17. The material of claim 1, comprising:
(a) a fibrous layer comprising
greater than 0 weight percent to about 20 weight percent binder, and from about 20 to less than about 100 weight percent inorganic fiber;
(b) an endothermic layer comprising
greater than 0 weight percent to about 20 weight percent binder;
from about 20 to less than 100 weight percent inorganic fiber; and
from about 1 to about 80 weight percent endothermic filler.

18. The material of claim 1, comprising:
(a) a fibrous layer comprising
about 95.5 weight percent inorganic fibers and about 4.5 weight percent binder; and
(b) an endothermic layer comprising
about 89.5 weight percent inorganic fibers;
about 4.5 weight percent binder; and
about 6.0 weight percent inorganic, endothermic filler.

19. The material of claim 1, wherein the weight ratio of endothermic filler to inorganic fiber is in the range of about 0.25:1 to about 30:1.

20. The material of claim 1, wherein the material is provided in the form a board sheet or board having a multilayered construction, wherein the material is provided in the form of shapes that are flexible, semi-rigid, or rigid.

21. The material of claim 1, wherein the material has a thickness in the range of about 20 to about 50 mm.

22. A method of protecting an article from fire comprising at least partially enclosing said article within the multilayer fire protection material of claim 1.

23. The method of claim 22, wherein the article has a fire facing side and a non-fire facing side, and the material is oriented so that the endothermic layer of the material faces the non-fire side of the article.

24. A method of forming a multilayer fire protection material comprising:
(a) providing at least a first aqueous slurry containing materials suitable for making a fibrous layer and at least a second aqueous slurry containing materials suitable for making an endothermic layer;
(b) depositing the first slurry onto a substrate;
(c) removing at least a portion of the liquid from the first slurry on the substrate to form a first fibrous layer;
(d) depositing the second slurry so as to form a second endothermic layer on the first fibrous layer;
(e) removing at least a portion of the liquid from the second layer; and
(f) drying the layers to form a multilayer material.
